(19) United States
(12) Patent Application Publication
(10) Pub. No.: US 2025/0111313 A1
(43) Pub. Date: Apr. 3, 2025

(54) INTELLIGENT DATA ORCHESTRATION AND TRANSFORMATION

(71) Applicant: Genpact USA, Inc., New York, NY (US)

(72) Inventors: Adrian Magram, Aventura, FL (US); Daniel Oprea, Bracknell (GB); Santiago Saca, Austin, TX (US); Anthony Buono, Brookline, MA (US); Praveen Vijayaraghavan, Slough (GB); Sandeep Singh, Chelmsford, MA (US); Vinod Dayalu, Watford (GB); Rohit Gupta, Feltham (GB)

(21) Appl. No.: 18/480,160

(22) Filed: Oct. 3, 2023

(51) Int. Cl. G06Q 10/0631

(52) U.S. Cl. CPC G06Q 10/06316

(57) ABSTRACT

A method and system for managing a digital workflow include identifying a task from a series of tasks associated with a project; determining a type of the project and to-be-collected information associated with the task; generating a user interface for presenting in an automated digital workflow application, wherein the user interface comprises one or more user interactive elements determined based on the type of the project and the to-be-collected information associated with the task; identifying trigger criteria associated with the task; interrogating a master data hub associated with the digital workflow to detect data associated with a task trigger; and in response to data associated with the task trigger satisfying the trigger criteria, automatically activating the task by causing the user interface to be displayed in the automated digital workflow application.

### TECHNICAL FIELD

This disclosure generally relates to computer systems and methods for designing workflow applications, and more particularly to techniques for configuring workflow applications with intelligent data orchestration and transformation for improved automation.

### BACKGROUND

A new product (finished goods) introduction workflow application is a software tool that automates tasks involved in a project or process to launch new products to market. Workflow applications route data along a predefined path until an item in the process is completed. Tasks in the workflow may include approvals, adding information, or data transfers. Workflow applications can be standalone applications that exist on their own or built on a platform where endless numbers of applications reside. Workflow applications can be manual or digital. Automated digital workflow applications have been transformative as they remove the hassles of requiring human intervention for repetitive tasks and mitigated risks, and thus an automated digital workflow application is a much sought-after efficiency tool among many industry verticals including food and beverage (alcoholic and non-alcoholic), manufacturing, IT, customer service, marketing, finance, etc.

Currently existing automated digital workflow applications for managing new product introduction (from innovation through commercialization) have certain problems and limitations. For example, automation of these digital workflow applications generally focuses on research & development (R&D) exclusively without covering inter-departmental processes, 3^{rd} party data integration, re-purposing of data from existing products, integration to other systems, intelligent data capture including digital assistant, among others. In addition, these existing digital workflow applications try to cover a broad range of industries without considering some unique features specific to certain industries, which drives many processes to still rely on error-prone manual processes in digital workflow applications.

Workflow automation systems and methods are thus needed to address these shortcomings.

### SUMMARY

To address the aforementioned shortcomings, a method and system for managing a digital workflow is provided. The method includes identifying a task from a series of tasks associated with a project (aimed at launching new products to market); determining a type of the project and to-be-collected information associated with the task; generating a user interface for presenting in an automated digital workflow application, wherein the user interface comprises one or more user interactive elements determined based on the type of the project and the to-be-collected information associated with the task; identifying trigger criteria associated with the task; interrogating a master data hub associated with the digital workflow to detect data associated with a task trigger; and in response to data associated with the task trigger satisfying the trigger criteria, automatically activating the task by causing the user interface to be displayed in the automated digital workflow application.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 is a block diagram of an example architecture for an automated digital workflow application system, according to embodiments of the disclosure.

FIG. 2A illustrates example components included in one instance of automated digital workflow application, according to embodiments of the disclosure.

FIG. 2B illustrates example components included in another instance of automated digital workflow application, according to embodiments of the disclosure.

FIG. 3 illustrates an example architecture for an automated digital workflow application, according to embodiments of the disclosure.

FIG. 4 illustrates an example logic architecture for an automated digital workflow application system, according to embodiments of the disclosure.

FIG. 5 is a flow chart of an example method for managing tasks in a digital workflow application, according to embodiments of the disclosure.

FIG. 6 is a block diagram of an example computer for an automated digital workflow application system, according to embodiments of the disclosure.

### DETAILED DESCRIPTION

The figures (FIGS.) and the following description relate to some embodiments by way of illustration only. It is to be noted that from the following description, alternative embodiments of the structures and methods disclosed herein will be readily recognized as viable alternatives that may be employed without departing from the principles of the present disclosure.

Reference will now be made in detail to several embodiments, examples of which are illustrated in the accompanying figures. It is to be noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Automated digital workflow applications focus on digital-based data and communication, and have found many industrial applications including, manufacturing, IT, customer service, marketing, finance, etc. However, existing automated digital workflow applications have many technical problems and limitations, e.g., failing to cover inter-departmental processes and failing to mimic specific industry-related workflows. For example, in the context of the creation and development of initiatives in the alcoholic beverage industry, there are processes and product particularities unique to the beverage industry. The processes may include, but are not limited to, the creation of new products, reformulation of an existing product, and release of an existing product to a new market. All these processes vary in the tasks needed to be completed and in the order tasks are triggered. The most common initiatives beverage organizations engaged in revolve around making a different version of an existing product by changing attributes such as size, flavor, alcohol by volume (ABV), label, shipper, etc. In such processes, being able to leverage attributes from existing products is key to increasing automation in the digital workflow applications, as this will allow users to only input the new attributes. Similarly, when it comes to data for the alcoholic beverage industry, there are industry-specific product details such as bottle type and size, ABV, liquid type, liquid origin, liquid appearance, carbonation, type of cap, % alcohol, bottles per case, type of label and its location, type of outer case, shipping container code (SCC), control state code (CSC), national alcohol beverage control association (NABCA) code, bottling site, etc. The existing workflow applications fail to mimic these industry-related workflows, thereby causing operational inefficiencies in the existing digital workflow applications as they create re-work, and in some cases create the need for manual intervention to give continuity to a project. In addition, failure to automatically handle industry-specific product attributes causes poor data quality as accuracy becomes a concern in human handling of the data in the existing digital workflow applications.

The present disclosure provides a technical solution to address the above technical problems of the existing digital workflow applications. In one embodiment, the disclosure provides an automated digital workflow application, which covers all functions involved in the process of creating an initiative in the digital workflow application. In addition, the tasks included in the disclosed digital workflow application are tailored to a specific industry (e.g., alcoholic beverage industry) with industry-specific entries & terminology for the digital workflow application. Furthermore, the tasks in the disclosed workflow application leverage predefined industry-specific rules to guide a user toward the correct path of the developed workflows. The tasks included in the disclosed workflow application also contain validations to ensure that users have entered all the critical information and that this data conforms to the data type for that specific industry. Moreover, the tasks are organized & triggered based on industry-specific project types and user-inputs to accurately meet the needs of the project. Doing so, the present disclosure provides a comprehensive automation platform where users can complete their tasks, share information, and conduct digital approvals with a high degree of fidelity to the process and a high degree of accuracy on the details related to the project.

It is to be noted that the benefits and advantages described herein are not all-inclusive, and many additional features and advantages will be further described under the context of specific embodiments. In addition, some additional features and advantages will become apparent to one of ordinary skill in the art in view of the figures and the following descriptions.

### Overall System

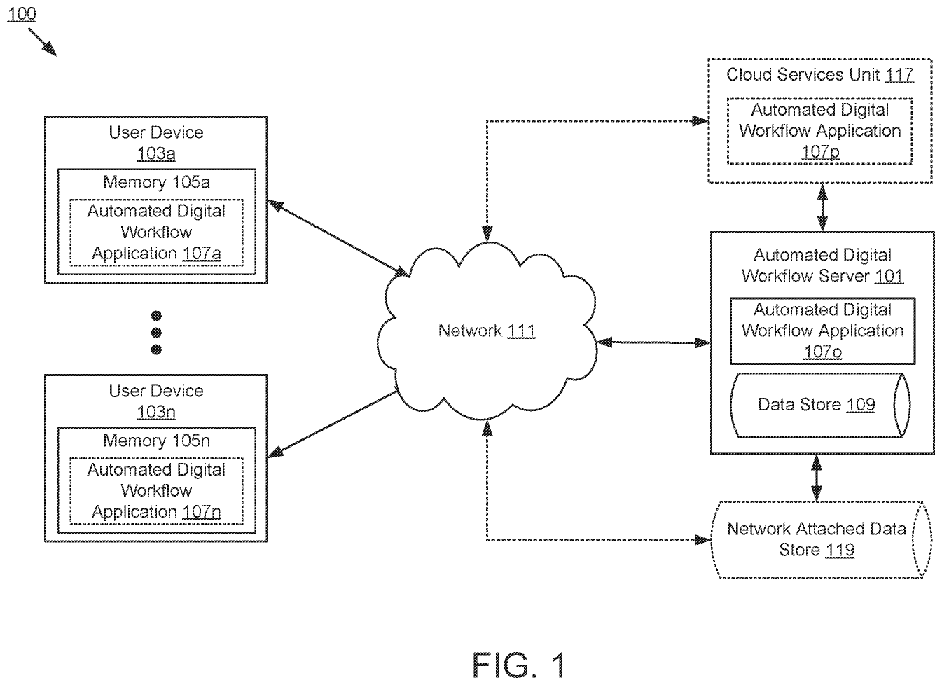

FIG. 1 is a block diagram of an example automated digital workflow application system 100, according to embodiments of the disclosure. The automated digital workflow application system 100 may be a network-based specialized computer environment for configuring workflows associated with a specific field by including intelligent data capture and orchestration and transformation within a digital workflow application for improved automation.

As illustrated in FIG. 1, the automated digital workflow application system 100 may include multiple user devices 103a . . . 103n, which can be specialized computers or other machines that are configured to provide inputs for specialized tasks included in one or more workflows associated with a project in a specific field (e.g., alcoholic beverage industry). In one example, the multiple user devices 103a . . . 103n (together or individually referred to as “user device 103”) may refer to multiple specialized computers associated with different entities of an organization, different departments of a company (e.g., a beverage company), different team members of a team, etc. Each specialized computer or user device may be configured to implement the same or different functions in an automated digital workflow application. For example, each user device 103 may optionally include an instance of automated digital workflow application 107a or 107n stored in a memory 105a or 105n, where each instance of automated digital workflow application may be configured to perform partial of full functions related to tasks and approvals in digital workflows associated with an organization, a company, or a team.

As will be described in detail later, an automated digital workflow application 107a or 107n on a user device may be configured to focus more on the implementation or completion of tasks and approvals related to digital workflows, while an instance of automated digital workflow application 107o included in an automated digital workflow server 101 is configured to focus more on the creation of tasks and approvals related to the digital workflows. In addition, in some embodiments, an instance of automated digital workflow application 107a or 107n included in a user device 103 may be configured to focus more on data collection and/or certain early stages of data processing (e.g., voice-to-text conversion, repurposing of data from existing products, rule-based data input, Gen AI for value suggestions, other), while an instance of automated digital workflow application 107o included in the automated digital workflow server 101 is configured to focus more on the later stages (e.g., data analysis) of data processing.

In some embodiments, a user device 103 may be a part of distributed computing topology, in which data collection and early stages of data processing are implemented close to the sites where tasks, events, or activities associated with the data occur. Distributed computing topology brings certain early stages of processing to the devices where it's being gathered, rather than relying all on a central location (e.g., automated digital workflow server 101) that can be thousands of miles away. This is done so that data, especially real-time data, does not suffer latency issues that can affect an automated digital workflow application's performance. In addition, the amount of data that needs to be sent to a centralized or cloud-based location is also reduced, which saves the bandwidth required by the workflow application.

As described above, the automated digital workflow application system 100 may additionally include an automated digital workflow server 101. According to some embodiments, the automated digital workflow server 101 may sit between user devices 103 and a data center (e.g., data store 109) or cloud (e.g., network attached data store 119) associated with an organization. By configuring an automated digital workflow server 101 in the automated digital workflow application system 100, it allows data orchestration and transformation to be implemented in workflows across multiple entities (e.g., through multiple user devices 103a . . . 103n) within an organization. In addition, in some embodiments, the automated digital workflow server 101 may be configured to have a higher computation power than the user devices 103, and thus some intensive data computations such as data analysis may be implemented on the server 101 instead, which saves the computation resources and/or reduces the requirement for computation power of each specific user device 103. In some embodiments, automated digital workflow server 101 may be separately housed from other devices within the automated digital workflow application system 100, such as user devices 103. Alternatively, an automated digital workflow server 101 may be part of a device or system, e.g., may be integrated with a user device 103 to form an integrated user device of the automated digital workflow application system 100.

In some embodiments, automated digital workflow server 101 may host a variety of different types of data processing capacities as part of the automated digital workflow application system 100, as will be described more in detail later. In addition, automated digital workflow server 101 may also receive a variety of different data from user devices 103, from cloud services unit 117, or other sources. The data may have been obtained or collected from one or more entities (e.g., through one or more user devices) or may have been received as inputs from an external system or device (e.g., through emails, mobile applications, web). In some embodiments, automated digital workflow server 101 may be configured to perform other functions not described above. For example, automated digital workflow server 101 may implement certain actions related to workflows, such as task and approval creation and management within an organization. In some embodiments, automated digital workflow server 101 may further implement additional functions unrelated to workflow applications, which are not limited in the present disclosure.

In some embodiments, automated digital workflow server 101 may communicate with other components of the system 100 through a data communication interface(s). For example, user devices 103 may collect and send data to the automated digital workflow server 101 to be processed therein, and/or may send signals to the automated digital workflow server 101 to control different aspects of the data it is processing, among other possibilities. User devices 103 may interact with the automated digital workflow server 101 through several ways, for example, over one or more networks 111.

Networks 111 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or a combination of wireless interfaces. As an example, a network in one or more networks 111 may include a short-range communication channel, such as Bluetooth or a Bluetooth Low Energy channel. A wired network may include a wired interface. The wired and/or wireless networks may be implemented using routers, access points, bridges, gateways, or the like, to connect devices in the system 100. The one or more networks 111 may be incorporated entirely within or may include an intranet, an extranet, or a combination thereof. In one embodiment, communications between two or more systems and/or devices may be achieved by a secure communications protocol, such as a secure sockets layer or transport layer security. In addition, data and/or task completion details may be encrypted.

In some embodiments, automated digital workflow application system 100 may further include one or more network-attached data stores 119. Network-attached data store 119 may be configured to store data managed by user devices 103 and/or the automated digital workflow server 101 in a cloud environment. Network-attached data store 119 may store a variety of different types of data organized in a variety of different ways and from a variety of different sources. For example, network-attached data store 119 may store unstructured (e.g., raw) data, such as audio and video data and hand-written graphs, or structured data.

In some embodiments, the automated digital workflow application system 100 may additionally include one or more cloud services units 117. A cloud services unit 117 may include a cloud infrastructure system that provides cloud services. In some embodiments, the computers, servers, and/or systems that make up the cloud services unit 117 are different from a user or an organization's own on-premises computers, servers, and/or systems.

In some embodiments, services provided by the cloud services unit 117 may include a host of services that are made available to users of the cloud infrastructure system on demand. For example, the services provided by the cloud services unit 117 may include, but are not limited to, machine learning model development, training, and deployment, messaging, social networking, data processing, image processing, audio-to-voice conversion, video-to-voice conversion, emailing services, intelligent analytics, Software as a service (SaaS), natural language processing, conversational artificial intelligence (AI), or any other services accessible to online users or user devices. In some embodiments, cloud services unit 117 may be utilized by the automated digital workflow server 101 as a part of the extension of the server, e.g., through a direct connection to the server or through a network-mediated connection.

In some embodiments, services provided by the cloud services unit 117 may dynamically scale to meet the needs of its users. For example, cloud services unit 117 may house one or more automated digital workflow applications 107p, which may be scaled up and down based on the number and complexity of tasks included in digital workflows at any time point.

It should be also noted that, while various devices, server, and services unit are illustrated in the automated digital workflow application system 100 in FIG. 1, it will be appreciated that more or fewer components may be used instead. For example, automated digital workflow server 101 may include a server stack. As another example, cloud services unit 117 and/or network-attached data store 119 may be not included in the automated digital workflow application system 100. In addition, in some embodiments, the functions included in each instance of automated digital workflow application 107a/107n/107o/107p (together or individually referred to as “automated digital workflow application 107”) in different devices may be the same or different. In one example, different instances of automated digital workflow application 107 from different devices collaboratively complete one or more functions. For example, one or more user devices 103 and the automated digital workflow server 101 may collaboratively serve as a hub for a product master data management (PMDM) project, where each instance of the application may perform a different layer of processes or functions. PMDM refers to an approach through which organizations organize and store information about all the key attributes of their suite of products. In the following, automated digital workflow application 107 included in the automated digital workflow server 101, user devices 103, or cloud services unit 117 will be described further in detail with reference to specific modules, engines, or components, and their associated functions.

### Automated Digital Workflow Application

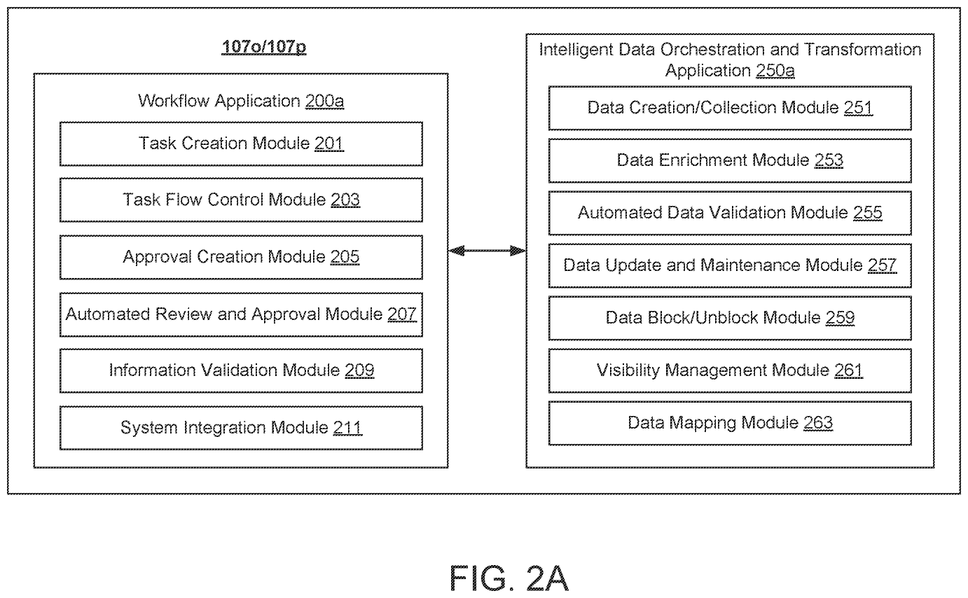

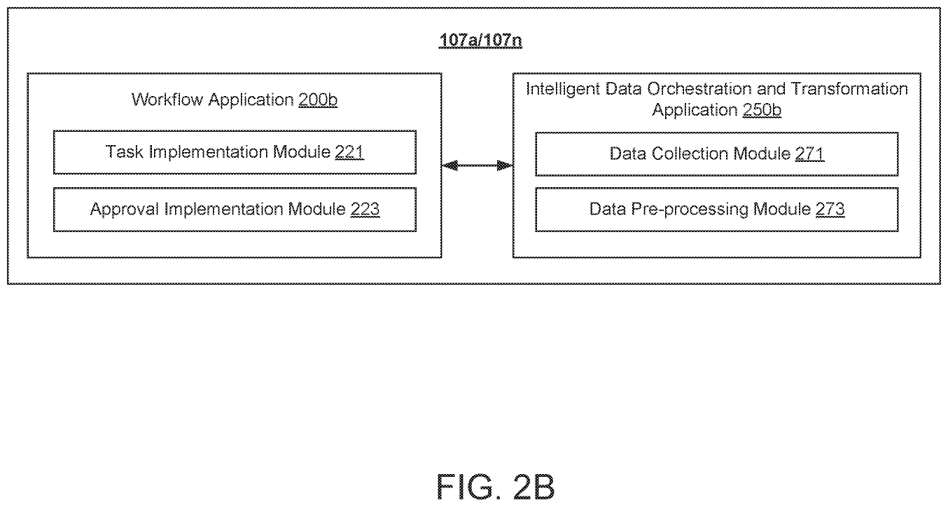

FIGS. 2A-2B illustrate example components included in an automated digital workflow application 107, according to some embodiments of the disclosure. Specifically, FIG. 2A illustrates example components included in an automated digital workflow application 107o in the automated digital workflow server 101 or automated digital workflow application 107p in the cloud services unit 117, and FIG. 2B illustrates example components included in an automated digital workflow application 107a/107n on a user device 103a/103n.

As illustrated in FIG. 2A, the automated digital workflow application 107o/107p may include a workflow application 200a and an intelligent data orchestration and transformation application 250a coupled to the workflow application 200a. The workflow application 200a may be more focused on monitoring processes/tasks included in workflows, e.g., monitoring tasks and approvals included in the workflows, while the intelligent data orchestration and transformation application 250a is more focused on the data flow within the workflow application, such as data collection, processing, and analysis for data related to workflows in the workflow application.

The workflow application 200a may include a task creation module 201, a task flow control module 203, an approval creation module 205, an automated review and approval module 207, an information validation module 209, and a system integration module 211. The intelligent data orchestration and transformation application 250a may include a data creation/collection module 251, a data enrichment module 253, an automated data validation module 255, a data update and maintenance module 257, a data block/unblock module 259, a visibility management module 261, and a data mapping module 263.

The task creation module 201 may be configured to create a series of tasks for a project. The series of tasks may serve to guide a user on the necessary details that need to be completed for the project under the digital workflow application environment. Once completed, tasks also serve as a repository of information from which the system can apply logic to trigger the right workflow and/or serve as a repository of information from which users can use as a reference at a later time. In some embodiments, there are different types of tasks and different numbers of tasks that may be created for each workflow included in a project, depending on the goal of the project. For example, for a project that aims to create a new beverage product, a series of tasks may include identifying product attributes, defining success criteria, performing preliminary risk analysis, artwork development, packaging development, packaging approval or certification, prototype development, claims and regulations activation, etc. In some embodiments, for each specific task, there may be some sub-tasks. For example, for artwork development, there may be different sub-tasks for specific logo, symbol, or pictogram development. There may be also sub-tasks for identifying a design agency for each development.

In some embodiments, when creating tasks (or sub-tasks), a user interface may be created for collecting information related to a task in the digital workflow application. The user interface may be configured in a way that reduces manual touchpoints and offline work by providing easy-to-use interfaces. For example, if possible, drop-down menus or check boxes may be used, instead of requiring users to input text when asking users to provide information or feedback related to a specific task in the digital workflow application.

In another example, rule-driven smart forms may be used for data collection in the digital workflow application when a task is created. For example, a rule engine may be included in the automated digital workflow application. Certain time-based reasoning, time-bound rules, and complex hierarchical data models may be included in the automated digital workflow application and/or may be used by the rule engine when receiving user inputs through the user interfaces in the digital workflow application. These rules and data models may be written in executable natural language. Accordingly, when collecting information related to specific tasks, the rule engine may offer detailed and elegant interactions with users by presenting questions backed up by these rules and models. For example, the rule engine may elegantly only ask for relevant inputs without presenting any irrelevant questions. The relevant questions asked may be dynamic in the sense that the questions depend on what data has been gathered according to time-based reasoning and time-bound rules. For example, a question about a cap size is relevant only if a type of beverage is stored in a bottle but not in a can. In some embodiments, instead of using a rule engine backed up by time-based reasoning, and time-bound rules, certain AI engines may be used instead to generate smart forms in task-related information collection in the digital workflow application.

The task flow control module 203 may be configured to leverage certain industrial field-specific rules to guide users towards a correct path for a created digital workflow. In some embodiments, one or more tasks and sub-tasks created for a project may be generated in a trigger and action format. For example, by including a trigger for a task or sub-task (together or individually may be simply referred to as “task” hereinafter), a task or an action associated with the task may be not activated if certain criteria are not met. In one example, the criteria may relate to information or feedback provided by a preceding task. If the information or feedback of the preceding task is incomplete or not properly provided, the criteria are considered as “not met,” and thus the task or the action associated with the task may be not activated or enabled. By setting up a series of triggers, it can be ensured that the series of tasks or actions be activated following a predefined order or correct path. In some embodiments, when building criteria for different tasks, certain industrial field-specific rules (e.g., rules in the beverage industry) may be followed to make sure the series of tasks are organized following a path consistent with these industrial field-specific rules.

The approval creation module 205 may be configured to create approvals or rejections for certain tasks included in a project. For example, many tasks in a project may require task executors to submit information related to their tasks, which may further require approval by the designated parties before the tasks are considered complete. In some embodiments, to facilitate the processing of approvals or rejections, one-click emails may be configured by the approval creation module 205. One-click approval links and tokens may allow approvers to approve or reject an entry directly from an email without having to open the workflow detail page. In some embodiments, approval links may be available only in the approval step assignee email, but not available in any other emails. In some embodiments, approvals or rejections may be generated in other different forms (e.g., in a workflow detail page with approval and rejection clicks or checkboxes).

Automated review and approval module 207 may be configured to automate the procedures or processes involved in an approval, overcoming all the drawbacks of the manual process and also weaving accountability and productivity into the fabric of the approval process. The specific automated review and approval procedures may include a series of steps that are followed in a particular sequence, including mapping out all the steps in an approval cycle, identifying supporting documents required, identifying criteria to be met at each approval level, identifying criteria for automatic approval/rejection, how the submission should be routed after approval/rejection, etc., all of which may be automated in the disclosed system 100. Automation of the approval workflow brings accountability, transparency, and consistency into the approval process.

The information validation module 209 may be configured to validate information submitted to the system 100. For example, in some embodiments, the information validation module 209 may be configured to implement certain validations to ensure that users have entered all the critical information, and that the entered data conform to the data type (e.g., industry-specific project type) for that specific entry. In some embodiments, tasks are organized and triggered based on industry-specific project types and user-inputs to accurately meet the needs of the project. By implementing the information validation, it can be also ensured that the tasks are properly and timely triggered.

The system integration module 211 may be configured to integrate the automated digital workflow application system 100 with other existing hardware, packaged and custom software, and communications. In one example, system integrations may allow the automated digital workflow application system 100 to connect with the digital ecosystem of an enterprise. System integrations allow the sharing of information between systems, pull and push, ensuring a single source of truth across various systems. For example, system integration may allow the automated digital workflow application system 100 to share data between SAP® enterprise resource planning (ERP) central component (SAP ECC) and SAP master data governance (SAP MDG) to supply and receive information relevant to a product.

In some embodiments, different techniques may be used in system integration, which may include, but are not limited to, computer networking, enterprise application integration, business process management, or even through manual programming. For example, one possible integration is common data format integration, which may avoid every adaptor having to convert data to/from every other application's format. In one example, the enterprise application integration technique may stipulate an application-independent (or common) data format. The enterprise application integration technique applied herein may provide a data transformation service as well to help convert between application-specific and common formats. This may be done in two steps. First, the adapter converts information from the application's format to the bus's common format of adaptors. Then, semantic transformations may be applied to this (e.g., converting zip codes to city names, splitting/merging objects from one application into objects in the other applications, and so on). Another possible system integration technique may relate to industrial lifecycle integration, which is a system integration process that considers four categories or stages of integration: initial system implementation, engineering and design, project services, and operations. This technique may incorporate the requirements of each lifecycle stage of the industrial asset when integrating systems and subsystems. The key output is a standardized data architecture that can function throughout the life of the asset. In some embodiments, other system integration techniques not described above may be contemplated by the present disclosure.

Referring now to the intelligent data orchestration and transformation application 250a, the data creation/collection module 251 included therein may be configured to coordinate with the data collection module (as will be described in detail later) on the user devices 103 to create and/or collect data required and generated during different workflow processes. For example, to complete an assigned task, a user may provide a detailed description of a bottle. For another example, to report a profit & loss, another user may create a profit & loss form and upload it to the system 100. All this information generated during the task implementation processes may be collected and stored for further processing and/or for future reference.

Data enrichment module 253 may be configured to enrich data through third-party integrations. As described above, system integration allows the automated digital workflow application system 100 to connect with the digital ecosystem of an organization or other third-party systems. System integrations allow the sharing of information between systems, pull and push, ensuring a single source of truth across systems. Through synchronization with other systems, a streamline may be created for capturing and tracking real-time data that comes from different sources. In one example, the automated digital workflow application system 100 may be enabled to share data between SAP ECC and SAP MDG to supply and receive information therebetween.

Automated data validation module 255 may be configured to automatically validate collected data without requiring human manipulation. In one example, the automated digital workflow application system 100 may include a front-end checker that automatically checks data errors to validate data accuracy and quality prior to data importing and processing. In some embodiments, data can be validated through scripts. For example, certain roles may be included in the automated digital workflow application, which can be used to verify all the necessary information within the required quality parameters. In some embodiments, data can be validated by programs. For example, a validation tool may be built into every step of a workflow.

In some embodiments, well defined data dictionary can be used to validate data at points-of-entry, ensuring the first time right of the data. For example, certain entries and terminology specific to an industry may be included in the automated digital workflow application system and can be used in data validation as well as the data collection process. For example, for an automated digital workflow application configured for the beverage industry, the automated digital workflow application may be configured to handle industry-specific product details such as bottle type and size, ABV %, liquid type, liquid origin, liquid appearance, carbonation, type of cap, bottles per case, type of label and its location, type of outer case, SCC, CSC, NABCA Code, bottling site, some or all of which may require a specific type or format of user inputs. The properly configured front-end checkers included in the system may allow user inputs to be properly collected and/or automatically validated.

Data update and maintenance module 257 may be configured to update data based on the actions detected in the workflows. For example, for a created project in a workflow that requires relevant entities to approve, if an entity selects “Approve,” the automated digital workflow application may automatically update the data to reflect the consent of the entity. In some embodiments, the data update and maintenance module 257 may periodically check whether there are some data updates, in case certain actions are not detected, thereby ensuring the data are timely updated.

Data block/unblock module 259 may be configured to block data that is no longer required for any purposes by an organization and to unblock the blocked data if the data is required again in exceptional cases by the organization. The blocked data is not deleted as it is still in the retention period. The blocked data generally is no longer available for display in existing objects, nor it can be used to edit, create new objects, or conduct follow-up activities with the blocked data. Blocked data can be unblocked only within the retention period since data is deleted after the retention period.

Visibility management module 261 may be configured to control the ability to access and view data in real-time. Managing data visibility can be a challenge when dealing with sensitive personal data, such as financial information or healthcare records. In such cases, it is important for an organization to implement strong data protection measures to ensure information security, and confirm that only authorized users have access to the data and the appropriate data permissions. In some embodiments, the automated digital workflow application disclosed herein may include or be coupled to a robust data management system, such as an ERP system. In some embodiments, the automated digital workflow application disclosed herein may additionally include data loss prevention tools to prevent accidental data loss. In some embodiments, the visibility management module 215 may be configured to manage the visibility of workflows, such as the status or needs for a project.

Data mapping module 263 may be configured to connect a data field from one source to a data field in another source. This reduces the potential for errors, helps standardize data and makes it easier to understand data. In addition, data mapping allows to bring the context into the workflow applications. Data mappings to users allow to select the right users to complete tasks and approvals. Furthermore, data mappings also provide a user with relevant information based on inputs previously given to the workflow applications. In some embodiments, data mappings also provide a visual representation of data movement and transformation with the automated digital workflow application system.

It should be noted that the above different modules are provided for exemplary purposes and not for limitations. In real applications, there may be additional functional modules or components included in an automated digital workflow application 107o/107p. In addition, depending on how each device included in the automated digital workflow application system is configured, one or more of the above-described modules 201-211 and 251-263 may be included in a user device 103 instead, for example, included in an automated digital workflow application 107a/107n, as further described in detail below.

Referring now to FIG. 2B, an instance of automated digital workflow application 107a/107n on a user device 103a/103n is further described. As illustrated, an automated digital workflow application 107a/107n may include an instance of workflow application 200b and an instance of intelligent data orchestration and transformation application 250b. The workflow application 200b on a user device may include a task implementation module 221 and an approval implementation module 223. The intelligent data orchestration and transformation application 250b may include a data collection module 271 and a data pre-processing module 273.

The task implementation module 221 may be configured to allow users to complete their tasks included in one or more workflows related to a project in the workflow application. Workflows generally connect tasks together, allowing for tasks to have a sequence and for different use cases to be integrated with the automated digital workflow application system 100. The sequence in the workflows is generally determined based on the inputs selected/input by users in the tasks and approvals. The automated digital workflow application system 100 includes certain system logic that when implemented triggers the right task flow according to the determined sequence.

This may include a display of user interfaces related to various tasks. Each user interface may include certain user interactive elements for receiving user inputs, which can be smart forms, tables, drop-down manus, check boxes, free text input fields, attachment links, upload links, etc. Through these interactive elements, users may provide the necessary information in completing their tasks for a project.

The approval implementation module 223 may be related to a stage when the information input through interactive elements may require approval by a designated party. Approvals generally bring relevant parties across multiple entities within an organization to review and/or revise completed tasks. Approvals allow leadership to have oversight of a project and make decisions on whether a project should continue to the next phase or not based on the details. In specific implementations, the approval implementation module 223 may be configured to forward an “approve” link to the designed party and monitor the approval process to ensure it is properly executed. If there is any feedback or instructions, the proper destination party may be further identified, and the feedback and instructions may be then forwarded to the identified party.

The data collection module 271 may be configured to gather data from various sources to identify insights such as trends and probabilities in workflows. This may include the collection of data input through user interfaces associated with workflows. In some embodiments, easy-to-use user interfaces and rule-driven smart forms can be used to reduce manual touchpoints and offline work. For example, certain user interfaces for receiving user inputs may include easy-to-use drop-down menu selections for many of the different possible fields. By using drop-down menus, the possibility of incorrect or invalid data inputs may be minimized. In some embodiments, certain rules may be further enforced in the data collection process. For example, certain data rules may be included in user inputs, which require users to provide rule-driven attributes and select from lists of acceptable values during user inputs. Rule-driven attributes mean that attributes may have permissible attribute configurations that are governed by certain attribute rules (e.g., user-defined rules). In some embodiments, user-defined rules may be used to automatically populate attributes, restrict invalid edits during edit operations, and perform quality assurance checks on existing features. Having rule-driven attributes and lists of acceptable values on user-entered fields is able to ensure high data quality. Failure to handle these types of data causes poor data quality as accuracy becomes highly dependent on its users.

Data pre-processing module 273 may be configured to pro-processing data collected through various sources. This may include converting unstructured data into structured data, such as voice-to-text conversion, etc. In some embodiments, the data pre-processing module 273 may further orchestrate the data collection process between different entities. For example, siloed data collected from multiple storage locations may be combined and organized, making it available for the following analysis. In some embodiments, the data orchestration process may also include a process of transforming data collected in different formats into a standard format, facilitating the subsequent data analysis. Other non-limited example data pre-processing may include, but are not limited to, data cleaning, instance selection, normalization, one hot encoding, and feature extraction and selection.

Referring back to FIGS. 2A-2B, in some embodiments, the automated digital workflow application 107 may include additional modules or components not described above. For example, the automated digital workflow application 107 may include additional modules or components configured to repurpose existing data for the creation of new records or to automatically identify duplicates, etc. In some embodiments, the automated digital workflow application 107 may further include an accelerator (e.g., an SAP MDG accelerator) for automating the process of SKU creation for workflow applications.

### Example Architectures

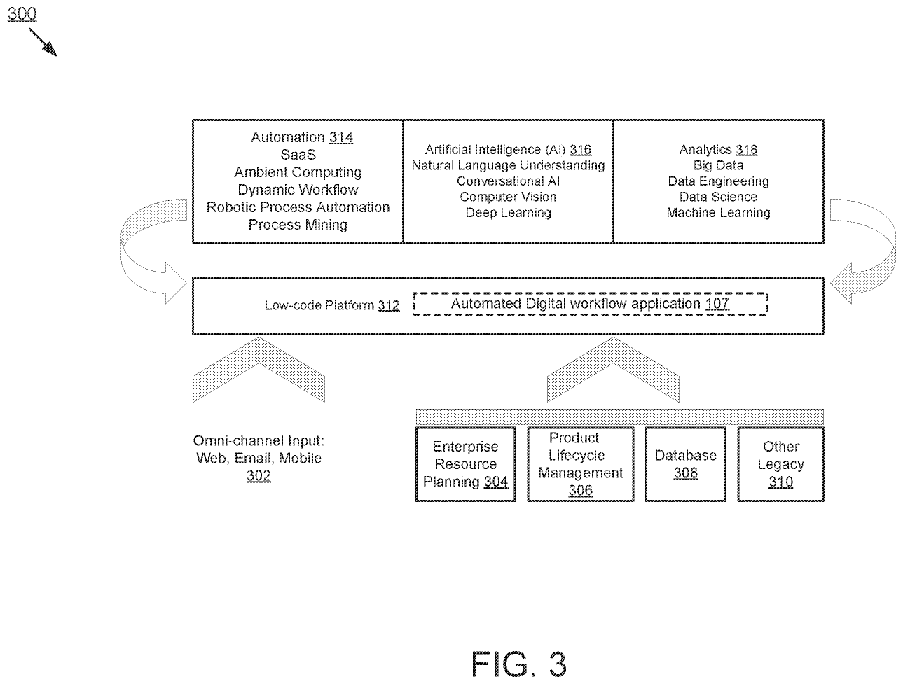

Referring now to FIG. 3, an example architecture 300 for implementing the automated digital workflow application 107 is further described. As illustrated, the automated digital workflow application 107 may be built upon a low-code platform 312 that enables the design and build of user interfaces, workflows, system integration, rules, and other possible functions associated with the automated digital workflow application 107. As also illustrated in FIG. 3, the low-code platform 312 may be communicatively coupled to many other tools or components facilitating the automated digital workflow application, which may include, but not is limited to, data collection, data integration, data processing, data analysis, and automation.

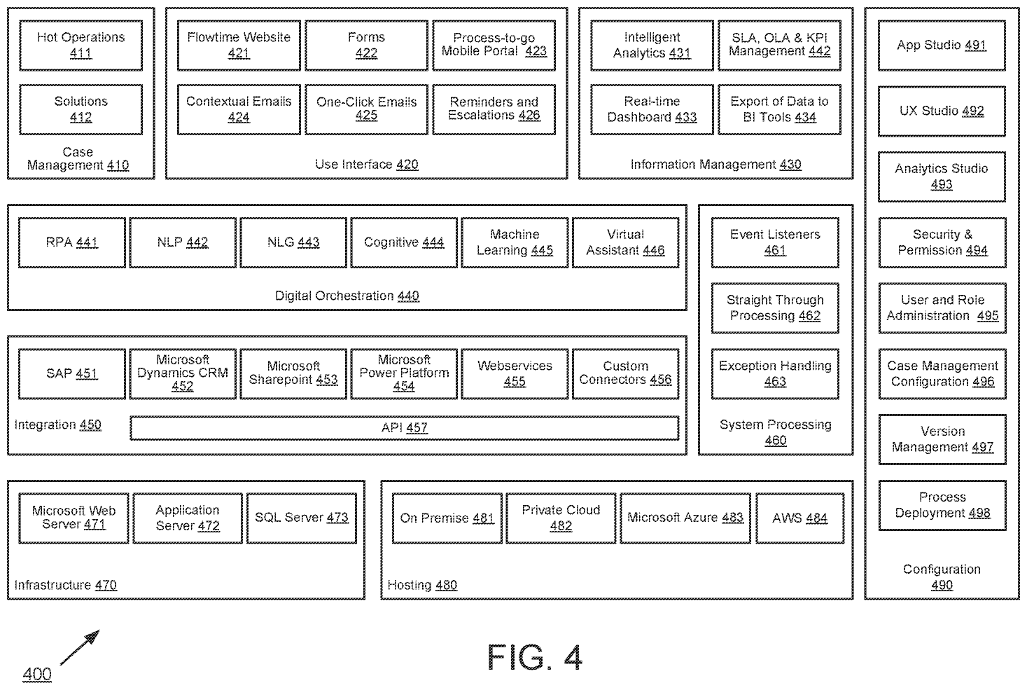

With respect to data collection and data enrichment, omni-channel input 302 may be used for data input through different channels, such as web, email, mobile, or other proper channels. For data integration, the automated digital workflow application 107 may be integrated with the other data management system for data enrichment and synchronization. Such systems may include, but are not limited to, ERP 304, product lifecycle management (PLM) 306, and other legacy (e.g., other data management systems) 310. In some embodiments, the automated digital workflow application 107 may be also coupled to a database 308 associated with the low-code platform 312. With respect to digital workflow automation, certain automation tools 314 may be applied to the automated digital workflow application 107. Such automation tools may include, but are not limited to, SaaS, ambient computing, dynamic workflow, robotic process automation, and process mining. With respect to data processing, certain AI tools 316 may be applied to the automated digital workflow application 107 for data processing. Such AI tools 316 may include, but are not limited to, natural language understanding, conversational AI, Gen AI, computer vision, and deep learning. With respect to data analytics, certain analytics tools 318 may be applied to the automated digital workflow application 107 for data analysis. Such analytics tools 318 may include, but are not limited to, dig data processing, data engineering, data science, and machine learning. In some embodiments, the automated digital workflow application 107 may be coupled to and/or may further include additional components, as described more in detail in FIG. 4.

FIG. 4 illustrates an example logical architecture 400 of the automated digital workflow application system, according to some embodiments of the present disclosure. As illustrated, the logical architecture of the automated digital workflow application system 100 may include a case management unit 410, user interfaces 420, a management information unit 430, a digital orchestration unit 440, an integration unit 450, a system processing logic 460, infrastructure 470, a hosting server 480, and configuration elements 490, all of which may support the intelligent data orchestration and transformation in workflow applications in different ways.

The case management unit 410 may be configured to manage use cases of workflows. This may include, but is not limited to, management of hot operations 411 and solutions 412 related to tasks included in the workflows. The hot operations 411 may include active operations that are being implemented in the automated digital workflow application system. The solutions may be a set of existing solutions (e.g., PLM solutions, marketing solutions, finance solutions, etc.) that can be leveraged for data orchestration and management in the digital workflow applications.

The user interfaces 420 refer to architectural components that allow a user to interact with the automated digital workflow application system. Example user interfaces may include, but are not limited to, flowtime website 421, forms 422, process-to-go mobile portal 423, contextual emails 424, one-click emails 425, and reminders and escalations 426. Flowtime website 421 allows to access tasks and see the status of a project, allowing users to view the progress of a project and access the task at hand. Forms 422 allow users to complete their tasks. Forms contain a variety of entries and textboxes where a user can complete their assigned task. Process-to-go mobile portal 423 may allow mobile devices to connect remotely with an organization intranet or extranet, typically via a web browser to access and action on certain to-be-completed processes or tasks. Contextual emails 424 and one-click emails 425 allow the system to communicate and complete tasks through emails. Communications include scenarios such as approval/rejection of a form and notifications for users to complete assigned tasks. One-click emails allow approvers to submit an approval/rejection via email. Reminders 426 allow to remind users to action on things inside an agreed timeframe, and may be sent to users who can action on the workflow step after a specified amount of time. Escalations 426 may include notifications to responsible entities that an activity has not been completed within the agreed time so that they may take remedial actions.

The information management unit 430 may be configured to manage information flow on the disclosed digital workflow application system. The information management unit 430 may provide functions including, but are not limited to, intelligent analytics 431, service level agreement (SLA), operational level agreement (OLA) & key performance indicator (KPI) management 432, real-time dashboard 433, and export of data to business intelligence (BI) tools 434. Intelligent analytics 431 may allow the automated digital workflow application system to collect, organize, and analyze big data, big information, big knowledge, and big intelligence as well as big wisdom in order to discover and visualize patterns, knowledge, and intelligence as well as other information within big data, information, knowledge, and intelligence. SLA, OLA & KPI management 432 may allow users to track critical KPIs such as time to market, first time right, number of open/completed projects, and time for completion for each different stage of the process. Real-time dashboards 433 may provide real-time insight into the status & progress of ongoing projects at different levels of granularity, such as project types and regions. Export of data to BI tools 434 may allow data to be exported to external BI tools that offer powerful (and high-speed) dashboarding and data analytics, cloud solutions, hyperintelligence, and so on.

The digital orchestration unit 440 may allow the automated digital workflow application system to leverage robotic process automation (RPA) and other tools by using product data and other data to aid users in their tasks. For example, the digital orchestration unit 440 may allow the automated digital workflow application system to automatically fill in details relevant to a product by using a reference product ID, increasing the efficiency of a user to complete a task. The digital orchestration unit 440 may include, but is not limited to, RPA 441, natural language processing (NPL) 442, natural language generation (NLG) 443, cognitive 444, machine learning 445, and virtual assistant 446 tools, all of which may aid users in tasks related to data processing and analysis and other different aspects of tasks. For example, RPA 441 may allow to build, deploy, and manage software robots that emulate human actions interacting with digital workflow applications. NPL 442 may allow the automated digital workflow application system to understand text and spoken words in much the same way human beings can. Cognitive 444 may reach into the realm of artificial intelligence in workflow applications by leveraging robotic process automation, machine learning, natural language processing, and natural language generation, etc. Machine learning 445 may allow the disclosed system to leverage data to improve computer performance by giving the system the ability to “learn” like a human in data processing in workflow applications. Virtual assistant 446 may be a digital assistant that facilitates information collection and responding to certain inquiries in the workflow applications.

The integration unit 450 may allow the automated digital workflow application system to communicate with other third-party systems, for example, by enabling the automated digital workflow application system to become part of an organization's digital ecosystem. Exemplary third-party systems and/or integration tools may include, but are not limited to, SAP 451, Microsoft Dynamic CRM 452, Microsoft SharePoint 453, and Microsoft Power Platform 454, webservices 455, and custom connectors 456. In one example, SAP MDG integration may allow the automated digital workflow application to send product details of a new product to SAP MDG to create an SKU. After an SKU is created, the automated digital workflow application system retrieves that information from SAP, allowing both systems to have the same product information. In another example, SAP ECC/S4 Hana integration allows the automated digital workflow application system to leverage relevant data from SAP. Such data may include, but are not limited to, product costing data, exchange rates, and bills of materials and vendors. In some embodiments, the automated digital workflow application system may also include one or more application programming interface(s) for system integration with third-party systems.

The system processing logic 460 refers to logic in the automated digital workflow application system that allows the system to handle dynamic workflows and exceptions. Exemplary processing logic may include, but is not limited to, event listeners 461, straight through processing logic 462, and exception handling logic 463. Event listeners 461 may be configured to allow the automated digital workflow application system to change its behavior when an event occurs, e.g., allowing the system to trigger the desired workflows or forms based on user inputs. For example, the event listeners 461 may allow to have dynamic forms only when relevant entries appear. Event listeners 461 may be also configured to allow the system to have multiple workflows such as product innovation and product extension within the system, and only listen to relevant events while there are different processes going on within the system. Straight through processing logic 462 is an automated process done purely through electronic transfers with no manual intervention involved. Exception handling logic 463 may be configured to allow the automated digital workflow application system to respond to unexpected events without disrupting or crashing the system, thereby enabling the smooth operation of the system.

The infrastructure 470 refers to the environment that allows the automated digital workflow application system to run over the internet. Exemplary infrastructure for the automated digital workflow application system may include, but is not limited to, Microsoft web server (e.g., Internet Information Services (IIS)) 471, application server 472, and Microsoft SQL server (e.g., SQL Azure) 473. Microsoft web server 471 may allow a developer of the automated digital workflow application system to host, deploy, and manage the website(s) where the automated digital workflow application runs. The application server 472 may contain the application logic, thereby enabling the automated digital workflow application system to display the desired behavior to users' user interfaces. The Microsoft SQL server 473 may contain tables that feed information to the automated digital workflow application system. These tables may include information such as the list of approvers, production plants, product information, and so on.

The hosting server 480 may allow a client to run a separate instance of the automated digital workflow application. Hosting can occur in a variety of ways depending on the needs of the client. For example, the hosting of the automated digital workflow application can be on premise 481, on a private cloud 482, on Microsoft Azure 483, on Amazon Web Service (AWS) 484, and so on. For on premise hosting 481, the automated digital workflow application can be hosted on the client infrastructure, allowing a client to manage the hardware and resources where the automated digital workflow application will run. For cloud hosting, the automated digital workflow application may be hosted by a variety of cloud providers, such as a private cloud 482, and public or commercial cloud providers, such as Microsoft Azure 483, AWS 484, and the like.

The configuration elements 490 refer to elements in the automated digital workflow application system that allow for the configuration and management of various functions or activities within the disclosed system. Example configuration elements may include, but are not limited to, app studio 491, user experience (UX) studio 492, analytics studio 493, security and permission element 494, user and role administration element 495, case management configuration element 496, version management element 497, and process deployment element 498. App studio 491 may provide an environment where workflows are configured and designed. UX studio 492 may provide an environment where tasks are created and edited. Analytics studio 493 may allow for the configuration of the analytics capacities of the automated digital workflow application system. In one example, the analytics capacities configuration may allow changes in the data/KPIs to be tracked and to determine how it is displayed to users. Security ad permission element 494 may allow to determine the data accessibility or visibility given to each user, especially when dealing with sensitive personal data, such as financial information or healthcare records. User and role administration element 495 may allow to determine a user's role and responsibility in a project. Based on the roles, the users may have also different data accessibility and visibility. Case management configuration element 496 may allow to configure case management of various use cases. Version management element 497 may allow the automated digital workflow application system to manage different versions of the automated digital workflow application. For example, the version management element 497 may allow the system to rollback to an older version in case there are issues with the deployment of the new version. Process deployment element 498 may allow the creation of a series of steps, allowing users to deploy the latest version of the automated digital workflow application.

### Example Methods

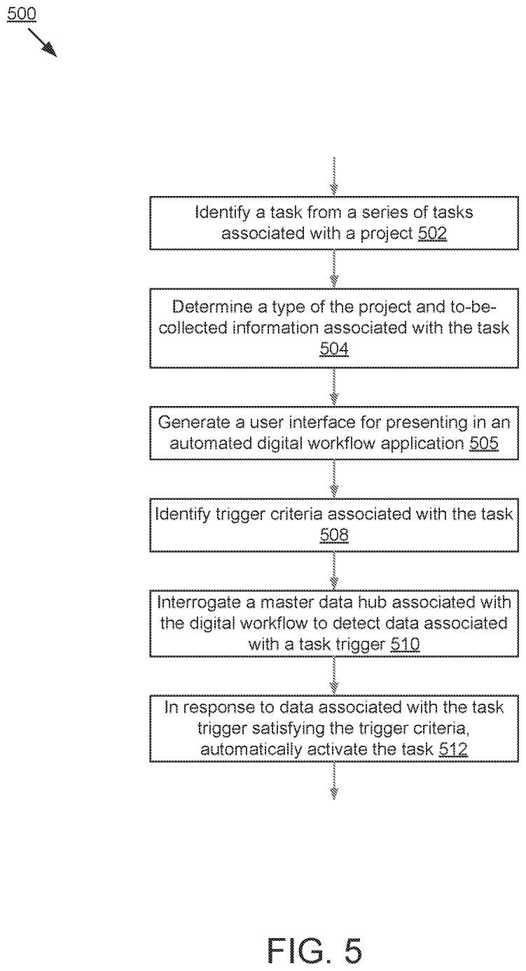

Referring now to FIG. 5, an example method 500 for managing a digital workflow is further described.

At step 502, method 500 includes identifying a task from a series of tasks associated with a project. Depending on the type and specific goal of the project, there may be different numbers and types of tasks associated with a project.

At step 504, method 500 includes determining the type of the project and to-be-collected information associated with the task. In some embodiments, the project type may be specific to an industry, since different industries may include different types of projects. For example, the specific tasks for the alcoholic beverage industry may be different from the tasks required for the aerospace industry. In addition, for each specific task included in a project, the information to be collected in the workflow application is also different.

At step 506, method 500 includes creating or generating a user interface for presenting in an automated digital workflow application. The user interface may include one or more user interactive elements, which may be determined based on the type of the project and the to-be-collected information associated with the task. In some embodiments, the one or more user interactive elements may include, but are not limited to, one or more of a smart form, a table, a drop-down menu, a check box, an attachment link, an upload link, or a free text input field. In some embodiments, the one or more user interactive elements may include one or more user input fields for inputting data related to rule-driven attributes, where the rule-driven attributes may be defined according to one or more rules associated with a specific industry (e.g., attributes specific to the beverage industry).

At step 508, method 500 includes identifying trigger criteria associated with the task. In some embodiments, a task included in a project is triggered to activate until certain criteria are satisfied. This can ensure that each task in the project is timely activated in the workflow application according to a predefined path.

At step 510, method 500 includes interrogating a master data hub associated with the digital workflow to detect data associated with a task trigger. In some embodiments, the data associated with the task trigger include the type of project and user inputs associated with one or more other tasks of the series of tasks associated with the project. For example, different project types may have different trigger events (e.g., user inputs) or trigger information (e.g., information indicating a completion of a preceding task). Accordingly, in some embodiments, the user inputs associated with one or more other tasks of the series of tasks include user inputs associated with one or more tasks preceding the task according to the predefined path.

At step 512, method 500 includes, in response to data associated with the task trigger satisfying the trigger criteria, automatically activating the task by causing the user interface to be displayed in the automated digital workflow application. In some embodiments, automatically activating the task includes automatically activating each of the series of tasks according to the predefined path. This can make sure that all tasks related to the project are sequentially completed in the digital workflow application according to the predefined path.

Although not shown in FIG. 5, in some embodiments, method 500 further includes receiving user inputs through the one or more user interactive elements in the user interface, where the user inputs reflect a user response to the to-be-collected information associated with the task. For example, to complete a task in the workflow, a user responsible for the task may input data through the one or more user interactive elements presented to the user. The input data may provide information in response to the request of the task, and thus reflect the user's response to the to-be-collected information associated with the task.

In some embodiments, method 500 further includes determining whether the user inputs reflecting the user response are valid by checking whether the user inputs conform to an industry-specific project type. This may ensure the validation of data collected at the point of entry, ensuring the first-time-right of the received data. In some embodiments, data dictionary and terminology may be used to validate the data to ensure all the critical information included in the data conforms to the data type for that specific industry. In some embodiments, other criteria may be used to validate the data.

In some embodiments, method 500 further includes identifying criteria for determining whether to approve or reject the user inputs reflecting the user response to the to-be-collected information associated with the task, and determining whether to approve or reject the user inputs by checking whether the user inputs satisfy the criteria. The criteria may include that the attributes of the data entry satisfy the specific project type, and that the user inputs cover all important information, among other possible criteria.

In some embodiments, method 500 further includes sending a one-click email to a designated party for approval or rejection.

In some embodiments, method 500 further includes converting the user inputs reflecting the user response to an adaptor bus's common format. The converted user inputs can be then integrated into one or more other applications for data synchronization.

In some embodiments, method 500 further includes storing data associated with the user inputs in the master data hub associated with the digital workflow.

In some embodiments, method 500 further includes processes not described above. For example, method 500 may further include any process or function implemented by the components included in the automated digital workflow application system in FIGS. 1-2B and components and logic included in the logical architecture in FIGS. 3-4.

### Example Applications

The following describes some specific processes that may be implemented in the automated digital workflow application system. As described earlier, the automated digital workflow application system may implement various processes (also referred to as “tasks” according to some embodiments) following a predefined path and automate each process in a digital workflow application. This includes the use of various tools and modules described above in data collection, transformation, validation, processing, analysis, integration, storage, and so on. The specific processes for such data orchestration and transformation are not specifically described in each process, and thus the following description may be limited to actual processes without necessarily repeating how the data are handled by the disclosed system in each process.

In a specific application, the automated digital workflow application system may be used in new product releases in the beverage industry. The new product release may include possible product innovation, product renovation, and product extension, each of which may include several variations to adapt to the diverse types of product releases a client may encounter. For example, product innovation may include a use case where a new product is introduced or when significant re-imagining of an existing product is done, where re-imaging of a new product may include changes in packaging, changes in formulation or both. Product renovation may include a use case where an existing product undergoes slight changes (e.g., 20% or less) to its formulation, packaging, or both. Product extension may include a use case where an existing product is released to a new market. Product extensions may be done with no essential changes to products, but there may be certain changes in tax label, and label content. Under certain circumstances, there may be also modifications to secondary packaging.

To initiate a new product release, a team in an organization may be given the right to begin a new data input process, whether that be for product creation or customer organization. This team may have a project lead role, and may request specific pieces of information once the new project is started. In the example of a new product release, the requested information may include, but is not limited to, market of interest, brand type, R&D Packaging. In the automated digital workflow application system, these inputs may include drop-down menu selections for many of the different possible fields. In some embodiments, free text inputs can be also used to allow users to type answers into systems and forms, and to add more detailed context to the data inputs obtained from drop-down menus. In some embodiments, the project lead may be also given the option to attach any general documents that could add more context to the project/customer.

Once the project has been submitted, the approval process begins. Specifically, the relevant entities that have stakes in the creation of this project may approve the inputs suggested by the project lead. Additionally and/or alternatively, the relevant entities may make edits, and then send the edited data back to the project lead. In some embodiments, the approval requests may be automatically sent via email to the relevant parties, where the email may be a one-click email including an “approve” or “reject” click. If a party selects “approve” in the automatic email, the automated digital workflow application system may be automatically updated to reflect the consent of the party. If a party selects “reject” or “rework” in the email, the party may be automatically brought to an automated digital workflow application system interface, where the party may make edits, which are then sent back to the project lead. Once approvals from all parties are received, the input interfaces requiring more detailed information may be automatically prompted.

In an example project related to a beverage product, the prompts may include, but are not limited to the following different categories. Prompts for original creation may require providing information related to the creation of the project, such as product information, project lead information, project creation date, etc. Prompts related to market analysis may require providing information for identifying the desired distribution channels, target demographic information, competitor analysis (e.g., measuring their volume and price to gage opportunities for market penetration), market trends, and a more detailed explanation of the possible opportunity. Prompts related to packaging material may require providing information for identifying whether a bottle for carrying the beverage will be an existing, new, or a modification of existing material, the type of material the bottle will be made from, the capacity of the bottle (in liters or milliliters). Once this information is collected, a free text field may be further prompted to allow users to create a detailed description of the bottle. Associated questions can be promoted to ask about the cap of the bottle. For example, a drop-down menu may be automatically generated to allow a selection of materials from metal, cork, and the like for the cap. In the next, a prompt may further ask about the label for the bottle, e.g., should a new, modified, or existing label be used?Once selected, a free text input may be automatically generated to allow more details to be input for the selected label type. In the next, more prompts may be generated asking for information related to secondary packaging. For example, a prompt may be generated to ask if the secondary packaging will use the existing, modified, or new packing, and another prompt may be further automatically generated to ask for information related to the material type by selecting from one of the following options: gift box, tray, case, outer case, and the like, all of which may be presented as drop-down menus. Additional prompts may be further generated to ask for information about the number of bottles per case, SCC pallet, whether the product requires special packing, and if the special packing is necessary, a free text input may be automatically generated to allow providing special instructions related to special packing. In the next, a prompt may be automatically generated to ask for the type of Incoterm, which may include drop-down menus including free on board (FOB), delivered at place (DAP) FOB, delivered duty paid (DDP), free alongside ship (FAS), etc. In some embodiments, a free text input may be further generated to ask for a description of a respective Incoterm description. In some embodiments, additional prompts may be automatically generated to ask for information related to support, such as information related to timetable, capital expenditures (CAPEX), cost of goods sold (COGS), and the like.

In some embodiments, when the above-described prompts are generated, the relevant entities responsible for providing information may be sent emails prompting the corresponding entities to complete their assignments. In one example, in the case of product data, examples of the assignments may include, but are not limited to, legal, logos, and packaging artwork. When completing the assignments, the legal documents, logos, and packaging artwork may be submitted to the created workflow in response to the emails sent to the respective entities. In some embodiments, the corresponding leader of a respective entity may be prompted to approve the submitted data or information (e.g., artwork). In some embodiments, when collecting the approvals, a user (e.g., project lead) may select recipients per each function. In some embodiments, a certain number of members (e.g., four members) may be chosen for each function type, such as COGS, inventory, hierarchy assignment, etc.

The above-described various processes may also referred to as a “create a user case” section in the new product release. In some embodiments, a workflow creation may further include an “additional project details” section, allowing additional information related to the project to be further input into the project created in the digital workflow application.

In the following, the specific details regarding the additional project details are further described. For example, there may be an input product attribute matrix automatically generated, which allows inputting the product attributes related to the product. In some embodiments, certain success criteria for the project are also defined, where the exemplary criteria may include, but are not limited to, cost, time of development, sigma level (a way of measuring the quality of a process or product), annual production cost, and the like. In some embodiments, a preliminary risk analysis may be also performed for the project. In some embodiments, the details related to the artwork development may be further included in the “additional project details” section. The details related to the artwork development may include, but are not limited to, a free text field for describing the design scope, an attachment link for attaching the design brief, a designation asking whether translation is necessary and the language(s) (e.g., through drop-down menu selections of popular languages) required if necessary. In some embodiments, the details related to the artwork development may also ask if a new agency is going to be used and the details regarding the new agency if it is to be used. The details of the new agency may include, but are not limited to, the vendor name, vendor code, vendor contact name, email, and phone number, etc. In some embodiments, the details related to the artwork development may allow to add a logo, symbol(s), and pictograms if needed. In some embodiments, once the tasks for providing the details regarding the artwork development are submitted, an approval request may be automatically sent to the designated approving party.

With respect to the packing development, the additional project details may include a section for the type of packaging used by a reference product if the reference product was selected by the commercial team. If not, a new packaging design may be necessary, which then prompts to the creation of tasks related to the new packing design. For example, a prompt may be generated to ask for vendor name, vendor code, contact name, other contact information, and so on. In addition, the technical files may be required to be sent to the vendor. After all information is filled in, the tasks related to the packaging development may be then sent to the designated approving party for approval. In some embodiments, the packaging may require to submit to governmental institutes or private organizations for approval or certification. The relevant tasks may include outlining the type of submission, preparing necessary documentation, providing the status tracking options (e.g., approved, approved with modification, rejected, and comments), and so on. In the United States and Canada, the packaging must seek approval by the NABCA code-specific private organization for certification. All the information, once collected, may also need to be sent to the designated party for approval.

With respect to prototype development, a user may receive a task with the option to select a reference product for prototype development or create new bulk materials without a reference product. The user may then outline the product's origin, carrier cost, quantity, unit cost, batch cost, cost per case, and so on. The user may be also prompted to add existing bulk material for prototype development. After all the relevant information is collected, the prototype development-related approvals are then sent to the designated party for approval.

In some embodiments, additional project details may further include information related to claims and regulation activation. For example, a free text field may be created to input legal and regulatory claims. The relevant task may be also generated for submission for approval.

In some embodiments, additional project details may further include information related to the cost of goods development. For example, drop-down menus or free text fields may be created to allow to add date, material number, material description, COGS type, unit of measure, total cost per case, total cost, etc. A link or window may be also created for adding COGS file. Once the necessary information is collected, the information may be submitted for approval from all relevant parties.

In some embodiments, additional project details may further include information related to inventory, overages, and obsoletes. For example, a link or window may be created for uploading an Excel file in the system with a list of materials and the relevant information related to inventory, overages, and obsoletes. The Excel file may be submitted after uploading.

In some embodiments, additional project details may further include information related to CAPEX. For example, a link or window may be created for uploading a CAPEX file in the system. The Excel file may be submitted after uploading.

In some embodiments, additional project details may further include information related to actual profit & loss. For example, an entity associated with the marketing/commercial sales team may create the profit & loss file, and upload the created file. The file uploaded to the system may be then sent to the designated party for approval.

In some embodiments, additional project details may further include information related to final product pricing. For example, an entity associated with financing may be promoted to upload the file regarding the final product pricing to the system. The file uploaded to the system may be then sent to the designated party for approval.

In some embodiments, additional project details may further include information related to the transfer price. For example, an entity associated with financing may attach a transfer price file and check the box to confirm the task has been completed. The file submitted to the system may be sent out for approval.

In some embodiments, additional project details may further include information related to product activation. For example, a PMDM team may receive the request for product activation. In some embodiments, the product activation may be also performed remotely in an integrated system, such as SAP.

In some embodiments, additional project details may further include information related to E-content validation. For example, a commercial team may receive the request for e-content validation and check the box to confirm the validation is complete.

In some embodiments, additional project details may further include information related to the publishing of a product to customers. For example, a commercial team may receive a task to publish a product to customers and check the box to confirm the task is complete.

In some embodiments, additional project details may include information other than those described above. In some embodiments, once all of the required information is complete, the approval process and data collection part of the workflow is complete. At this point, the data may flow to the master data management hub. Possible tools for flowing the data may include, but are not limited to, MDG, ECC, Oracle, etc. In some embodiments, all the collected data may be stored in a SAP system or another equivalent system.

From the above descriptions, it can be seen that the automated digital workflow application system 100 may be used to create a product master data project where tasks are automatically generated and assigned to all users involved in the related processes. That is, the automated digital workflow application system may act as a single source for data collection and as a collaboration space between different functions for workflow applications.

### Implementing Device

In some embodiments, the various automated digital workflow application systems disclosed herein, may be implemented on a computing system with access to a hard disc or remote storage, as further described in detail below.

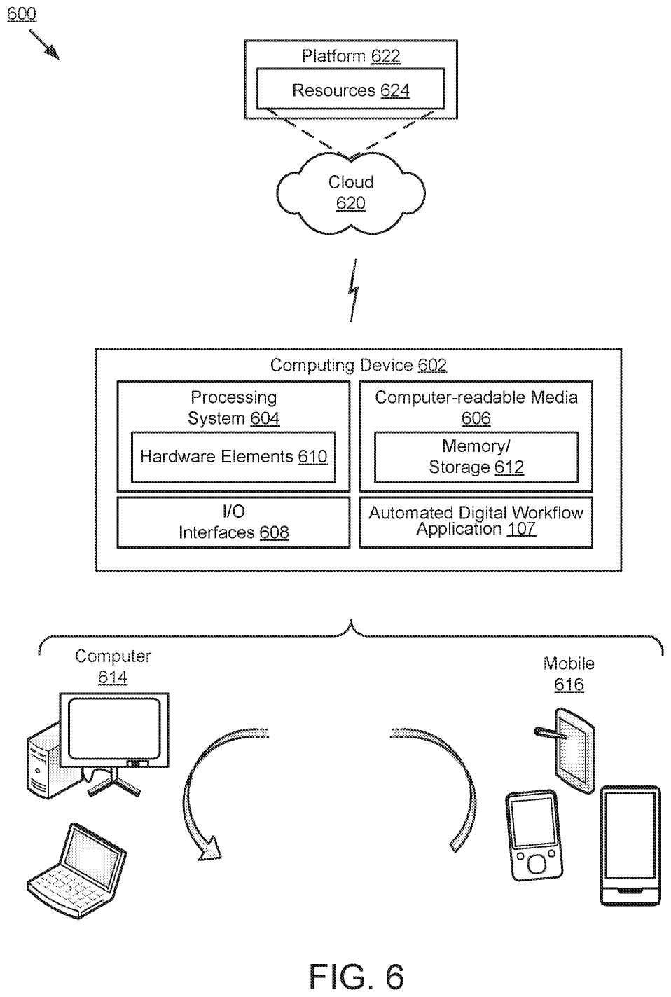

FIG. 6 illustrates an example system 600 that, generally, includes an example computing device 602 that is representative of one or more computing systems and/or devices that may implement the various techniques described herein. The computing device 602 may be, for example, a user device 103, a cloud services unit 117, or an automated digital workflow server 101 as shown in FIG. 1, an on-chip system embedded in a device (e.g., IoT), and/or any other suitable computing device or computing system.

The example computing device 602 as illustrated includes a processing system 604, one or more computer-readable media 606, and one or more I/O interfaces 608 that are communicatively coupled, one to another. Although not shown, the computing device 602 may further include a system bus or other data and command transfer system that couples the various components, from one to another. A system bus may include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of the functionality to perform one or more operations using hardware. Accordingly, the processing system 604 is illustrated as including hardware element 610 that may be configured as processors, functional blocks, and so forth. This may include implementation in hardware as an application-specific integrated circuit (ASIC) or other logic devices formed using one or more semiconductors. The hardware elements 610 are not limited by the materials from which they are formed, or the processing mechanisms employed therein. For example, processors may be comprised of semiconductor(s) and/or transistors, e.g., electronic integrated circuits (ICs). In such a context, processor-executable instructions may be electronically executable instructions.

The computer-readable media 606 is illustrated as including memory/storage 612. The memory/storage 612 represents memory/storage capacity associated with one or more computer-readable media. The memory/storage 612 may include volatile media (such as random-access memory (RAM)) and/or nonvolatile media (such as read-only memory (ROM), Flash memory, optical disks, magnetic disks, and so forth). The memory/storage 612 may include fixed media (e.g., RAM, ROM, a fixed hard drive, and so on) as well as removable media, e.g., Flash memory, a removable hard drive, an optical disc, and so forth. The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movements as gestures that do not involve touch), and so forth. Examples of output devices include a display device (e.g., a monitor or projector), speakers, a printer, a network card, a tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “unit,” “component,” and “engine” as used herein generally represent software, firmware, hardware, or a combination thereof. The features of the techniques described herein are platform-independent, meaning that the techniques may be implemented on a variety of commercial computing platforms having a variety of processors.

As previously described, hardware elements 610 and computer-readable media 606 are representatives of modules, engines, programmable device logic, and/or fixed device logic implemented in a hardware form that may be employed in one or more implementations to implement at least some aspects of the techniques described herein, such as to perform one or more instructions. Hardware may include components of an integrated circuit or on-chip system, an ASIC, a field-programmable gate array (FPGA), a complex programmable logic device (CPLD), and other implementations in silicon or other hardware. In this context, hardware may operate as a processing device that performs program tasks defined by instructions and/or logic embodied by the hardware as well as hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of an engine that is executable by the computing device 602 as software may be achieved at least partially in hardware, e.g., through the use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

As further illustrated in FIG. 6, the example system 600 enables ubiquitous environments for providing one or more device-specific AI engines, which can be further personalized. This improves the performance of an AI engine not only due to its compatibility with specific device constraints but also due to its personalized output.

In the example system 600, multiple devices are interconnected through a central computing device. The central computing device may be local to multiple devices or may be located remotely from the multiple devices. In one embodiment, the central computing device may be a cloud of one or more server computers that are connected to multiple devices through a network, the internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a family of target devices is created, and experiences are tailored to the family of devices. A family of devices may be defined by physical features, types of usage, or other common characteristics of the devices.

In various implementations, the computing device 602 may assume a variety of different configurations, such as for computer 614 and mobile 616 uses, and for many enterprise use, IoT user, and many other uses not illustrated in FIG. 6. Each of these configurations includes devices that may have generally different constructs and capabilities, and thus the computing device 602 may be configured according to one or more of the different device classes. For instance, the computing device 602 may be implemented as the computer 614 family of a device that includes a personal computer, desktop computer, multi-screen computer, laptop computer, netbook, and so on. The computing device 602 may also be implemented as the mobile 616 family of devices that include mobile devices, such as a mobile phone, a portable music player, a portable gaming device, a tablet computer, a wearable device, a multi-screen computer, and so on. In some embodiments, the devices may be classified according to their constraints instead, as described earlier.

The techniques described herein may be supported by these various configurations of the computing device 602 and are not limited to the specific examples of the techniques described herein. This is illustrated through the inclusion of an automated digital workflow application 107 on the computing device 602, where the automated digital workflow application 107 may include different units or modules as illustrated in FIGS. 1-4. The functionality represented by the automated digital workflow application 107 and other modules/applications may also be implemented all or in part through the use of a distributed system, such as over a “cloud” 620 via a platform 622 as described below.

The cloud 620 includes and/or is representative of platform 622 for resources 624. The platform 622 abstracts the underlying functionality of hardware (e.g., servers) and software resources of the cloud 620. Resources 624 may include applications and/or data that can be utilized while computer processing is executed on servers that are remote from the computing device 602. Resources 624 can also include services provided over the internet and/or through a subscriber network, such as a cellular or Wi-Fi network.

The platform 622 may abstract resources and functions to connect the computing device 602 with other computing devices 614 or 616. The platform 622 may also serve to abstract the scaling of resources to provide a corresponding level of scale to encountered demand for the resources 624 that are implemented via platform 622. Accordingly, in an interconnected device implementation, the implementation functionality described herein may be distributed throughout system 600. For example, the functionality may be implemented in part on the computing device 602 as well as via the platform 622 which abstracts the functionality of the cloud 620.

### Additional Considerations

While this disclosure may contain many specifics, these should not be construed as limitations on the scope of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Under certain circumstances, multitasking and parallel processing may be utilized. Moreover, the separation of various system components in the implementations described above should not be understood as requiring such separation in all implementations, and it should be understood that the described program components and systems may generally be integrated together into a single software or hardware product or packaged into multiple software or hardware products.

Some systems may use certain open-source frameworks for storing and analyzing big data in a distributed computing environment. Some systems may use cloud computing, which may enable ubiquitous, convenient, on-demand network access to a shared pool of configurable computing resources (e.g., networks, servers, storage, applications, and services) that may be rapidly provisioned and released with minimal management effort or service provider interaction.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situations where only the disjunctive meaning may apply.

What is claimed is:

1. A computer-implemented method for managing a digital workflow, comprising:
identifying a task from a series of tasks associated with a project;
determining a type of the project and to-be-collected information associated with the task;
generating a user interface for presenting in an automated digital workflow application, wherein the user interface comprises one or more user interactive elements determined based on the type of the project and the to-be-collected information associated with the task;
identifying trigger criteria associated with the task;
interrogating a master data hub associated with the digital workflow to detect data associated with a task trigger; and
in response to data associated with the task trigger satisfying the trigger criteria, automatically activating the task by causing the user interface to be displayed in the automated digital workflow application.

2. The computer-implemented method of claim 1, wherein the one or more user interactive elements comprise one or more of a smart form, a table, a drop-down menu, a check box, an attachment link, an upload link, or a free text input field.

3. The computer-implemented method of claim 1, wherein the one or more user interactive elements comprise one or more user input fields for inputting data related to rule-driven attributes.

4. The computer-implemented method of claim 3, wherein the rule-driven attributes are defined according to one or more rules associated with a specific industry.

5. The computer-implemented method of claim 1, wherein automatically activating the task comprises automatically activating each of the series of tasks according to a predefined path.

6. The computer-implemented method of claim 5, wherein the data associated with the task trigger comprise the type of project and user inputs associated with one or more other tasks of the series of tasks associated with the project.

7. The computer-implemented method of claim 6, wherein the user inputs associated with one or more other tasks of the series of tasks comprise user inputs associated with one or more tasks preceding the task according to the predefined path.

8. The computer-implemented method of claim 1, further comprising:
receiving user inputs through the one or more user interactive elements in the user interface, wherein the user inputs reflect a user response to the to-be-collected information associated with the task.

9. The computer-implemented method of claim 8, further comprising:
determining whether the user inputs reflecting the user response is valid by checking whether the user inputs conform to an industry-specific project type.

10. The computer-implemented method of claim 8, further comprising:
identifying criteria for determining whether to approve or reject the user inputs reflecting the user response to the to-be-collected information associated with the task; and
determining whether to approve or reject the user inputs reflecting the response by checking whether the user inputs satisfy the criteria.

11. The computer-implemented method of claim 10, further comprising:
sending a one-click email to a designated party for approval or rejection.

12. The computer-implemented method of claim 1, further comprising:
converting the user inputs reflecting the user response to an adaptor bus's common format.

13. The computer-implemented method of claim 12, wherein the converted user inputs are integrated into one or other applications for data synchronization.

14. The computer-implemented method of claim 1, further comprising:
storing data associated with the user inputs in the master data hub associated with the digital workflow.

15. A system for managing a digital workflow, comprising:
a processor; and
a memory, coupled to the processor, configured to store executable instructions that, when executed by the processor, cause the processor to perform operations comprising:
identifying a task from a series of tasks associated with a project;
determining a type of the project and to-be-collected information associated with the task;
generating a user interface for presenting in an automated digital workflow application, wherein the user interface comprises one or more user interactive elements determined based on the type of the project and the to-be-collected information associated with the task;
identifying trigger criteria associated with the task;
interrogating a master data hub associated with the digital workflow to detect data associated with task trigger; and
in response to data associated with the task trigger satisfying the trigger criteria, automatically activating the task by causing the user interface to be displayed in the automated digital workflow application.

16. The system of claim 15, wherein automatically activating the task comprises automatically activating each of the series of tasks according to a predefined path.

17. The system of claim 15, wherein the operations further comprise:
receiving user inputs through the one or more user interactive elements in the user interface, wherein the user inputs reflect a user response to the to-be-collected information associated with the task.

18. The system of claim 17, wherein the operations further comprise:
determining whether the user inputs reflecting the user response are valid by checking whether the user inputs conform to an industry-specific project type.

19. The system of claim 17, wherein the operations further comprise:
identifying criteria for determining whether to approve or reject the user inputs reflecting the user response to the to-be-collected information associated with the task; and
determining whether to approve or reject the user inputs reflecting the response by checking whether the user inputs satisfy the criteria.

20. The system of claim 19, wherein the operations further comprise:
sending a one-click email to a designated party for approval or rejection.
